(19) United States
(12) Patent Application Publication
(10) Pub. No.: US 2008/0084465 A1
(43) Pub. Date: Apr. 10, 2008

(54) Air dryer tunnel

(75) Inventors: Dave Telken, St. Peters, MO (US); John Dick, Milford, OH (US); Kevin Stone Manes, St. Charles, MO (US); David Kuhn, St. Charles, MO (US); Mikhail Goldburt, Ballwin, MO (US)

Correspondence Address: FOLEY AND LARDNER LLP;SUITE 500, 3000 K STREET NW, WASHINGTON, DC, 20007, US

(73) Assignee: MARK ANDY, INC.

(21) Appl. No.: 11/543,309

(22) Filed: Oct. 5, 2006

(51) Int. Cl. B41J 2/00

(52) U.S. Cl. 347/102

(57) ABSTRACT

An air dryer tunnel, including an impingement section and an exhaust section. The impingement section may include a hot air inlet, and a corrugated impingement nozzle shroud including rows of orifices positioned at least one of at and proximate apexes of the corrugation of the nozzle shroud. The orifices may be in fluid communication with the hot air inlet. The exhaust section may include an exhaust air outlet in fluid communication with the orifices of the impingement nozzle shroud.

### BACKGROUND OF THE INVENTION

Flexographic printing is a process which utilizes inks deposited on a web, such as a paper web, to impart images onto the web. Flexographic printing utilizes water based inks which must be dried onto the web so as to avoid smearing and/or running of the ink, and to increase printing speeds/times. The present invention relates to a device for improving the drying speed of inks during flexographic printing.

### SUMMARY OF THE INVENTION

In an embodiment of the present invention, there is an air dryer tunnel, comprising an impingement section, including an air inlet; and a corrugated impingement nozzle shroud including rows of orifices positioned at least one of at and proximate apexes of the corrugation of the nozzle shroud, the orifices being in fluid communication with the air inlet. The tunnel includes an exhaust section, including an exhaust air outlet in fluid communication with the orifices of the impingement nozzle shroud. In another embodiment of the present invention, there is an air dryer tunnel as described above or below, wherein the corrugated impingement nozzle shroud comprises a single sheet of metal. In another embodiment of the present invention, there is an air dryer tunnel as described above or below, wherein the corrugated impingement nozzle shroud comprises a single piece of stamped sheet metal.

In another embodiment of the present invention, there is an air dryer tunnel as described above or below, wherein the corrugated impingement nozzle shroud includes corrugation in the form of V shaped channels substantially parallel to one another. In another embodiment of the present invention, there is an air dryer tunnel as described above or below, wherein the corrugated impingement nozzle shroud include flat sections linking the legs of the V shaped channels that are horizontal when the V shaped channels are viewed upright.

In another embodiment of the present invention, there is an air dryer tunnel as described above or below, wherein the corrugated impingement nozzle shroud includes corrugation that forms a first set of channels substantially parallel to one another having a triangular cross-section in a plane normal to the direction of the first set of channels. In another embodiment of the present invention, there is an air dryer tunnel as described above or below, wherein the corrugated impingement nozzle shroud includes corrugation that forms a second set of channels substantially parallel to one another having a trapezoidal cross-section in a plane normal to the direction of the second set of channels, wherein the second set of channels are opposite the first set of channels with respect to sides of the impingement nozzle shroud, wherein channels of the first set and second set are located in an alternating manner in a direction normal to the direction of the channels; and wherein first respective legs of the triangular cross-sections are shared with first respective legs of the trapezoidal cross-section and wherein respective second legs of the triangular cross-sections are shared with second legs of the trapezoidal cross-section, the first and second legs of the trapezoidal cross-section being the non-parallel legs of the trapezoidal cross-sections.

In another embodiment of the present invention, there is an air dryer tunnel as described above or below, wherein the air dryer tunnel is configured to create a pressure gradient such that air flows from the air inlet to the orifices and through the orifices; the corrugated impingement nozzle shroud includes corrugation that forms a first set of channels on a first side of the corrugated impingement nozzle shroud to direct air from the air inlet to the orifices, channels of the first set of channels being substantially parallel to one another and configured to substantially increase velocity of the air moving from the air inlet to the orifices.

In another embodiment of the present invention, there is an air dryer tunnel as described above or below, wherein the corrugated impingement nozzle shroud includes corrugation that forms a second set of channels substantially parallel to one another on a second side of the corrugated impingement shroud opposite the first side to direct air that has traveled through the orifices towards the exhaust air outlet.

In another embodiment of the present invention, there is an air dryer tunnel as described above or below, wherein the exhaust section further comprises a plurality of elongated dividers located on the second side of the corrugated impingement shroud, wherein elongated dividers are positioned between apexes of the corrugated impingement nozzle shroud and include exhaust openings in fluid communication with the orifices of the impingement section and the exhaust air outlet, the dividers being configured to isolate the exhaust section from the impingement section.

In another embodiment of the present invention, there is an air dryer tunnel as described above or below, wherein the air dryer tunnel is configured to create a pressure gradient such that air flows from the air inlet to the orifices and through the orifices; the exhaust section comprises exhaust openings in fluid communication with the orifices of the impingement section and the exhaust air outlet, wherein the orifices of the impingement section are in fluid communication with the exhaust openings, and wherein the total area of the orifices is about ¼ of the total area of the exhaust openings.

In another embodiment of the present invention, there is an air dryer tunnel as described above or below, wherein the air dryer tunnel is configured to create a pressure gradient such that air flows from the air inlet to the orifices and through the orifices; the exhaust section comprises exhaust openings in fluid communication with the orifices of the impingement section and the exhaust air outlet, wherein the orifices of the impingement section are in fluid communication with the exhaust openings, and wherein the nozzle apexes are positioned about 2⅜ inches from each other.

In another embodiment of the present invention, there is an air dryer tunnel as described above or below, wherein the air dryer tunnel is configured to create a pressure gradient such that air flows from the air inlet to the orifices and through the orifices at a rate of about 10,000 feet per minute.

In another embodiment of the present invention, there is an air dryer tunnel as described above or below, further comprising a resistance heater configured to heat air flowing into the air inlet. In another embodiment of the present invention, there is an air dryer tunnel as described above or below, further comprising a web support proximate to the corrugated impingement nozzle shroud, wherein the air dryer tunnel is configured to accept a paper web and permit the paper web to pass between the web support and the corrugated impingement nozzle shroud at a web running speed, the orifices of the corrugated impingement nozzle shroud configured to direct heated air onto the web that passes between the web support and the corrugated impingement nozzle shroud, the distance between the web support and the corrugated impingement nozzle shroud being adjustable.

In another embodiment of the present invention, there is an air dryer tunnel as described above or below, wherein the corrugated impingement nozzle shroud includes corrugation having a form selected from the group consisting of wave shaped channels, U shaped channels, converging hyperbola shaped channels, and V shaped channels, the channels being substantially parallel to one another.

In another embodiment of the present invention, there is an air dryer tunnel as described above or below, wherein the exhaust section further comprises a plurality of elongated dividers, wherein individual elongated dividers are positioned between apexes of the corrugated impingement nozzle shroud, and include exhaust openings in fluid communication with the orifices of the impingement section and the exhaust air outlet, the dividers being configured to isolate the exhaust section from the impingement section.

In another embodiment of the present invention, there is an air dryer tunnel as described above or below, wherein the orifices are substantially elliptical, where the major axis of the oval is about 0.130 inches and the minor axis is about 0.032 inches.

In another embodiment of the present invention, there is an air dryer tunnel as described above or below, wherein there are at least about 130 orifices per row, wherein the exhaust openings are in rows substantially parallel to the rows of orifices, wherein median diameter of the exhaust openings is substantially greater than median diameter of the orifices.

In another embodiment of the present invention, there is a method of manufacturing an air dryer as described above or below.

In another embodiment of the present invention, there is a method of manufacturing an air dryer tunnel for a printing press, comprising the actions of obtaining a piece of sheet material; placing a plurality of rows of through holes in the sheet material; plastically deforming the sheet material along the rows of through holes to impart corrugation in the sheet material, the rows of through holes being least one of at and proximate at least some apexes of the respective corrugation; and attaching the sheet material to an air dryer tunnel including an air inlet such that the through holes are in fluid communication with the air inlet and at least some of the apexes of the corrugation of the sheet material having the through holes are away from the air inlet with respect to a direction of fluid traveling from the air inlet to the through holes.

In another embodiment of the present invention, there is a method of manufacturing an air dryer as described above or below, wherein the through holes are punched through the sheet material and the plastic deformation action takes place subsequent to punching the holes through the sheet material. In another embodiment of the present invention, there is a method of manufacturing an air dryer as described above or below, wherein the plastic deformation action comprises stamping the sheet material to plastically deform the sheet material to obtain the corrugation.

In another embodiment of the present invention, there is a method of manufacturing an air dryer as described above or below, wherein the plastic deformation includes deforming the sheet material to obtain corrugation in the form of V shaped channels substantially parallel to one another. In another embodiment of the present invention, there is a method of manufacturing an air dryer as described above or below, wherein the plastic deformation action comprises bending the sheet material along the rows of through holes to a predetermined angle. In another embodiment of the present invention, there is a method of manufacturing an air dryer as described above or below, further comprising attaching a plurality of elongated dividers to the air dryer tunnel such that the elongated dividers are positioned between apexes of the corrugation, the elongated dividers including exhaust openings such that the exhaust openings are in fluid communication with the orifices of the impingement section when attached to the air dryer tunnel.

### BRIEF DESCRIPTION OF THE DRAWINGS

FIG. 1 depicts an exploded isometric view of an air dryer tunnel assembly according to an embodiment of the present invention.

FIG. 2 presents a cross sectional side view of the embodiment depicted in FIG. 1.

FIG. 3 presents an isometric view of a corrugated impingement nozzle shroud according to an embodiment of the present invention.

FIG. 4 presents a close up view of a portion of the impingement nozzle shroud depicted in FIG. 3.

FIG. 5 is a cross sectional view of the corrugated impingement nozzle shroud of FIG. 3.

FIGS. 6 through 8 present exemplary alternate configurations of a corrugated impingement nozzle shroud according to the present invention.

FIG. 9 presents an exemplary layout of the orifices of the nozzle shroud according to an embodiment of the present invention.

FIG. 10 depicts an isometric view of an embodiment of the dryer tunnel.

FIG. 11 depicts an exaggerated view of a cross-section of the embodiment of FIG. 10.

FIG. 12 depicts a transparent view of FIG. 11.

FIG. 13 is an exploded assembly view of the dryer tunnel of FIG. 11

FIGS. 14-18 depict components presented in FIG. 13.

FIGS. 19 and 20 depict the flow of exhaust air through the dryer tunnel of an embodiment of the present invention.

FIG. 21 depicts a nozzle shroud and support structure according to another embodiment of the present invention.

### DETAILED DESCRIPTION OF ILLUSTRATIVE EMBODIMENTS

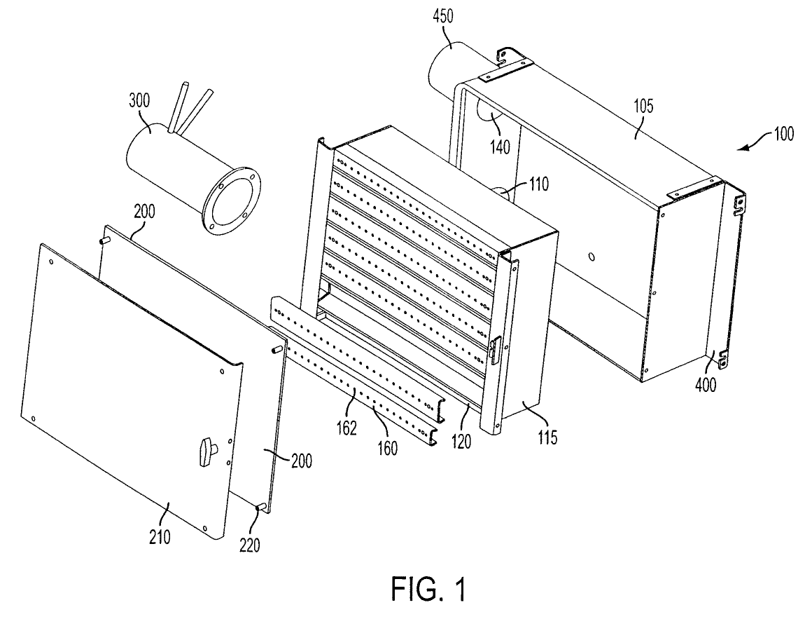

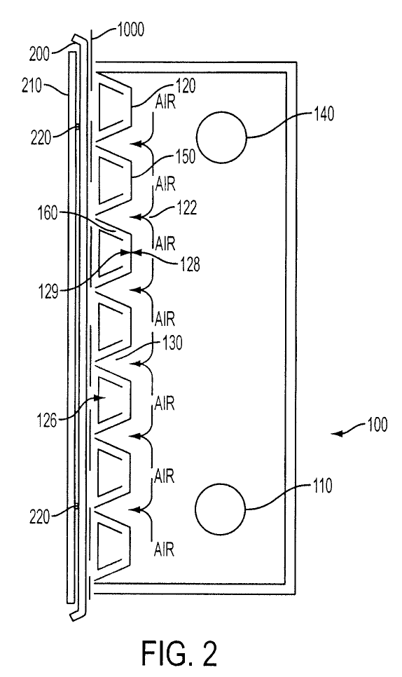

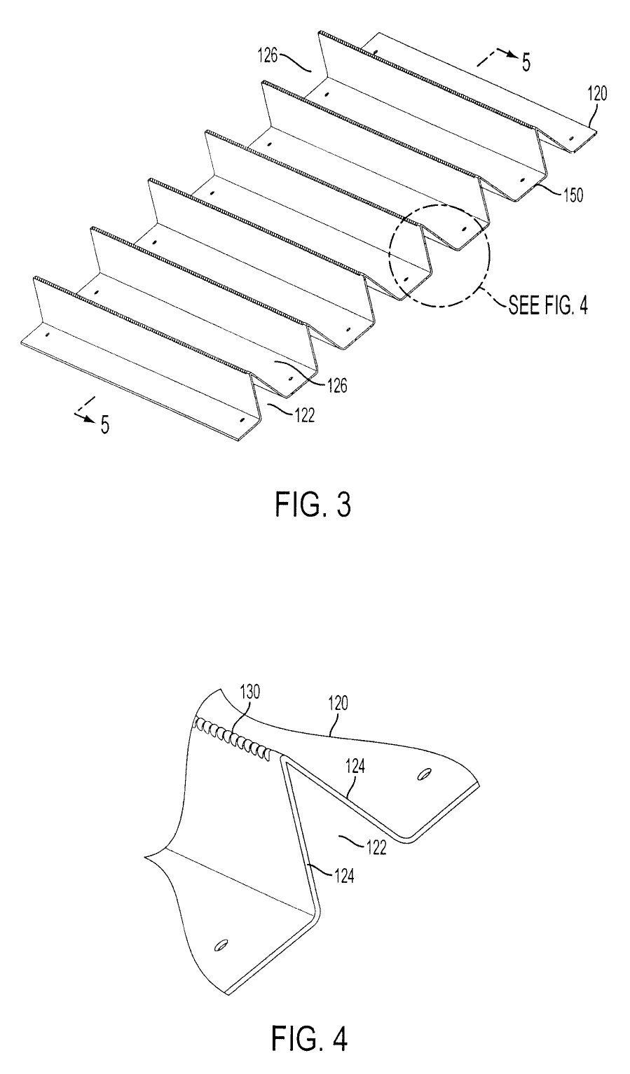

FIGS. 1 and 2 depict an exploded isometric view of an air dryer tunnel assembly, which may utilize hot air so as to be a hot air dryer tunnel, according to a first embodiment of the present invention. (Also, embodiments of the present invention may include utilizing other gasses, such as nitrogen, carbon dioxide, etc.) Specifically, an air dryer tunnel 100 is shown. The air dryer tunnel includes a chassis 105, an impingement section (constituting a means for impinging air onto a web), which includes an air inlet 110 and a corrugated impingement nozzle shroud 120, which in FIGS. 1 and 2 is depicted as an impingement nozzle plate. The corrugated impingement nozzle shroud 120, which is in plate form as depicted in FIGS. 1-5, includes rows of orifices 130 (see FIGS. 3 and 4) positioned at/proximate apexes of the corrugation of the nozzle shroud 120, the orifices being in fluid communication with the air inlet 110. The air dryer tunnel 100 further includes an exhaust air outlet 140 in fluid communication with the orifices 130 of the impingement nozzle shroud 120. In FIG. 1, element 115 is an insert that includes the shroud that fits into chassis 105.

An embodiment of the present invention includes a dryer tunnel 100 as depicted by way of example and not by limitation in the figures, which may be attached to a printing press, such as a flexographic printing press (an exemplary embodiment of such a press may be seen in U.S. Pat. No. 6,520,082 to Goldburt and Telken, issued Feb. 18, 2003, the contents of this patent being incorporated herein by reference in their entirety). In some embodiments, an existing printing press may be reconfigured to mate with the dryer tunnel 100, while in other embodiments, printing presses may be manufactured with the dryer tunnel 100 as part of the press. The dryer tunnel 100 may be configured such that the dryer tunnel 100 may be placed in a web path (e.g., a paper web) of a flexographic printing press (or any other such printing press with which the present invention may be utilized) such that the web of the printing press passes through the tunnel 100 as depicted in FIG. 2, where the web has been given reference numeral 1000. Accordingly, some embodiments of the present invention may include mounting devices on or about the tunnel 100, such as, for example, reinforced fittings or brackets 400, as may be seen in FIG. 1 to enable/expedite mounting of the dryer tunnel 100 onto a printing press.

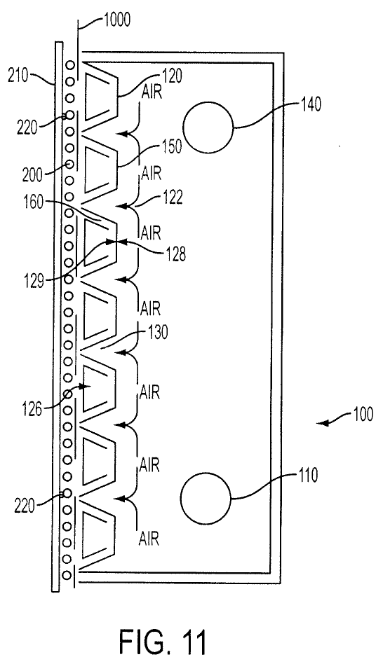

Embodiments of the air dryer tunnel 100 may be utilized to direct impingement air onto a web as depicted in FIGS. 2 and 11. In this regard, the air dryer tunnel 100 is configured with rods (such as glass rods) to form a web support 200, as may be seen in FIG. 11 (in other embodiments, the web support 200 may be a shroud, such as shown in FIG. 2) proximate to the corrugated impingement nozzle shroud 120 so that the web 1000 may be accepted by air dryer tunnel 100 and so as to permit the web 1000 to pass between the web support 200 and the corrugated impingement nozzle shroud 120 at a standard web running speed of 0 to about 1000 feet per minute. (In some embodiments, the rods are aligned with the apexes of the nozzle shroud 120.) A door 210 is provided with the air dryer tunnel 100, which in some embodiments, is a hinged door. The door 210 may support the support shroud 200 with attachment fasteners 220 (bolts, screws, rivets, jackscrews, scissor supports, etc.). In some embodiments, the attachment fasteners 220 are adjustable to allow for the position of the support shroud 200 to be adjusted to accommodate/provide sufficient clearance for the web 1000.

Some embodiments of the present invention may include a resistance heater 300 positioned upstream from the air inlet 110 configured to heat air flowing into the tunnel 100.

Specific features of various embodiments of the air dryer tunnel 100 will now be described, with reference to the figures where appropriate.

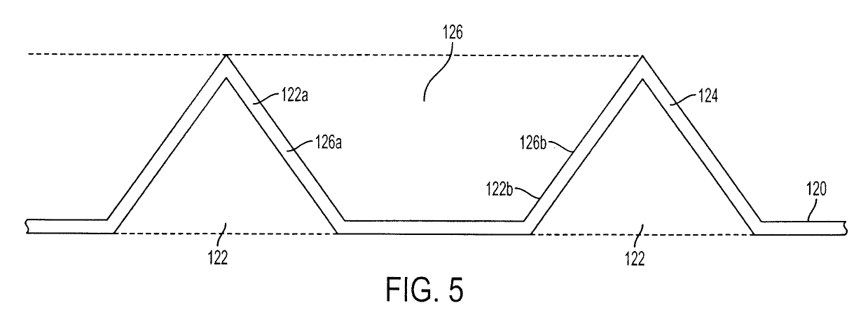

In the first embodiment of the present invention, the corrugated impingement nozzle shroud comprises a single sheet, as is depicted in FIG. 3, which, in some embodiments, is stamped sheet metal having corrugation in the form of V shaped channels 122 substantially parallel to one another. (In other embodiments, the nozzle shroud may be made from plastic, carbon fiber, cellulose, etc.) As may be seen in FIGS. 1-4, the corrugated impingement nozzle shroud includes flat sections 150 linking the legs 124 of the V shaped channels. In an embodiment of the present invention, the flat sections 150 are aligned to be horizontal when the V shaped channels are viewed upright (or, conversely, aligned to be vertical when the V shaped channels are viewed on their side, such as may be seen in FIGS. 2 and 11). The corrugated impingement nozzle shroud 120 includes corrugation that forms a first set of channels 122 substantially parallel to one another having a triangular cross-section (see FIG. 5) in a plane normal to the direction of the first set of channels.

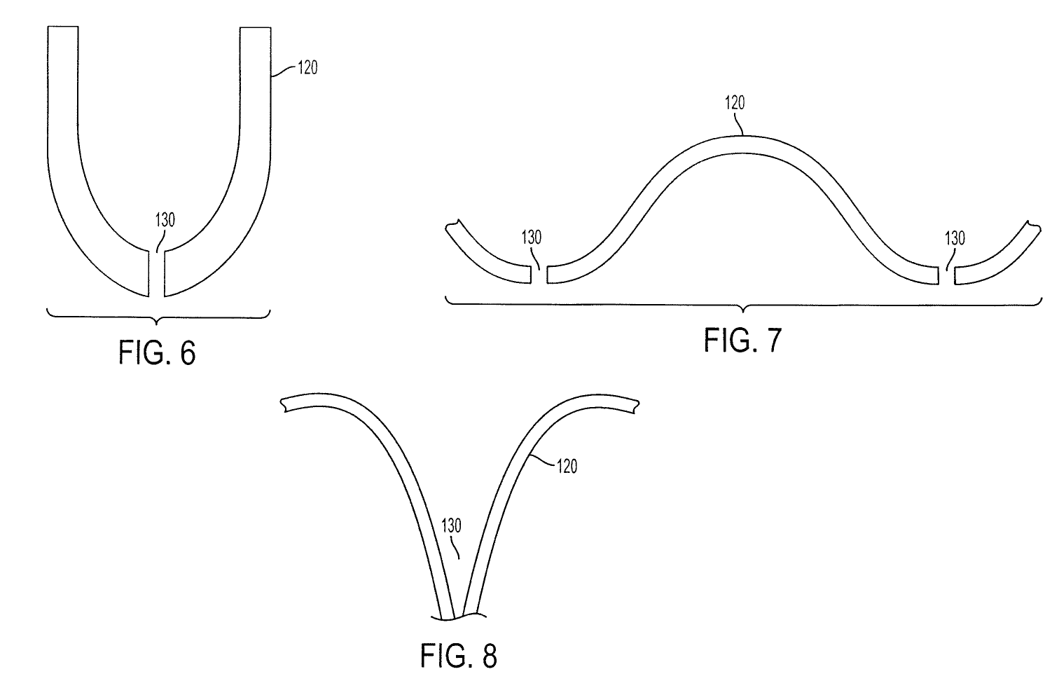

It is noted that other embodiments of the present invention may utilize different configurations of corrugations. For example, U shaped channels, wave shaped channels and/or converging hyperbola shaped channels might be formed in the shroud 120, as is illustrated by way of example in FIGS. 6-8.

FIG. 5 also details how in some embodiments of the present invention, the corrugated impingement nozzle shroud includes corrugation that forms a second set of channels 126 substantially parallel to one another having a trapezoidal cross-section in a plane normal to the direction of the second set of channels, wherein the second set of channels 126 are opposite the first set of channels with respect to sides 128/129 (see FIGS. 2 and 11) of the corrugated impingement nozzle shroud 120. In this example, channels of the first set and second set are located in an alternating manner in a direction normal to the direction of the channels along the plate. That is, referring to FIG. 5, going from left to right, the channels alternate (trapezoidal cross section channel on the top (side 129), triangular cross-section channel on the bottom (side 128), trapezoidal cross-section channel on the top side (side 129), etc.). In such embodiments, first legs 122a of the triangular cross-sections are shared with first legs 126a of the trapezoid cross-sections. Moreover, second legs 122b of the triangular cross-sections are shared with second legs 126b of the trapezoid cross-sections. Here, the first and second legs 126a and 126b of the trapezoidal cross-sections are the non-parallel legs of the trapezoidal cross-sections.

It will be noted that the corrugated impingement nozzle shrouds 120 according to some embodiments of the present invention may comprise separate components (e.g., each channel is formed by a separate piece of structure), which may be, for example riveted/bolted (etc.) together, welded together, glued together, or folded together, etc. Other embodiments include a solid shroud of single piece construction which may be obtained by stamping, bending, etc, as will now be more fully discussed below. Other embodiments may utilize other materials to form the nozzle shrouds 120 (e.g., plastic/carbon fiber, cellulose product, etc.)

An exemplary embodiment of manufacturing the corrugated impingement nozzle shroud 120 includes manufacturing the shroud 120 from a piece of sheet metal (which may be stainless steel) and first placing a plurality of rows of through holes in the sheet metal in lines parallel to one another. After this, the piece of sheet metal may be plastically deformed along/adjacent the rows of through holes to impart corrugation in the sheet as described herein. Plastic deformation may be obtained through stamping of the sheet metal (or other sheets of other types of material, as applicable), bending of the sheet to desired angles, etc. Other embodiments may obtain the corrugation by extrusion of the sheet (in which case the through holes may be generated after the extrusion process, or even put in the shroud during the process). Extrusion may be used, for example, in the case of a plastic nozzle shroud. Other embodiments may be practiced by fabricating a number of individual sections of the corrugated impingement nozzle shroud (e.g., a plurality of V shaped components) and attaching them to one another. The rows of through holes may be at apexes (some or all of the apexes) of the respective corrugation, and/or may be proximate to apexes (some or all of the apexes) of respective corrugation.

The corrugated impingement nozzle shroud 120, once fabricated, may then be attached to the chassis of an air dryer tunnel 100 by any suitable method (welding, bolting, screw attachment, etc.), such that the through holes are in fluid communication with an air inlet 110 of the tunnel, at least some of the through holes being at/proximate apexes of the corrugation, these through holes being positioned away from the air inlet with respect to a direction of fluid traveling from the air inlet 110 to the through holes. Other components of the air dryer tunnel 100 may then be added (such as, for example, the addition of elongated dividers along the lines detailed below).

It is noted that the manufacturing actions just described may be implemented in another sequence. For example, the elongated dividers may be attached to the corrugated impingement nozzle shroud 120 prior to installation of the impingement nozzle shroud 120 onto the tunnel 100, etc.

As detailed above, embodiments of the air dryer tunnel are configured to direct impingement air onto a web passing between the door 210 and the nozzle shroud 120. In some embodiments, the orifices 130 of the corrugated impingement nozzle shroud 120 are configured to direct heated air onto the web 1000 that passes between the web support 210 and the corrugated impingement nozzle shroud 120. As detailed above, the distance between the web support 200 and the corrugated impingement nozzle shroud 120 may be adjustable (such as by a mechanical jack screw or scissor system, etc.). In some embodiments, the distance is adjustable over a range of about 0 inches to about ½ inch from the web 1000 to the orifices of the impingement shroud 120. In some embodiments, the tunnel is practiced such that the distance is about ¼ of an inch from the web 1000 to the orifices.

It is to be noted that this feature plays a part in controlling impingement air characteristics. For example, the further the distance of the web from the orifices, the lower the force of the air onto the web, and visa-versa, etc.

In some embodiments, the apexes having the through holes of the nozzle shroud 120 are located about ¼ inch from the support shroud 200 when the door 210 is closed (the thickness of the web being relatively negligible in some embodiments).

In some embodiments, the nozzle apexes are positioned about 2 and ⅜ inches from each other. In some embodiments, the apexes may be positioned about 1 inch and greater apart from each other. The support 200 may be made from glass rods. In other embodiments, a variety of material such as sheet metal and/or nonmetallic materials, aluminum, etc., may be used, and the support may be coated with PTFE. Some embodiments of the present invention will utilize a low friction material/a material that has a low friction coating, so as to provide increased compatibility with the paper web that passes through the air dryer tunnel 100. Indeed, some embodiments of the present invention may include a support 200 that comprises a series of idler rolls and/or nonmetallic support bars.

Some embodiments of the air dryer tunnel 100 operate by having the tunnel create a pressure gradient such that air flows from the air inlet 110 to the orifices 130 and through the orifices 130. In this regard, the corrugated impingement nozzle shroud 120 with its first set of channels 122 on a first side 128 of the corrugated impingement nozzle shroud 120 directs air from the air inlet 110 along the first side of the shroud to the orifices 120 (the web 1000 and the door 210 being positioned on the second side 129 of the nozzle shroud 120). The channels 122 are configured to substantially increase velocity of the air moving from the air inlet 110 to the orifices 130. In some embodiments, the channels 122 are configured to create a Venturi effect on the air flow to increase the speed of the air flow through the orifices. The air that flows through the orifices 120, having gained kinetic energy due to the Venturi effect, impinges onto the web 1000 at a heightened speed. In some embodiments, the shape, size, etc., of the orifices and/or holes may be different in different channels, and may be different in the same channels.

In an exemplary embodiment of the invention, the air dryer tunnel 100 is configured to create a pressure gradient such that air flows from the air inlet 110 to the orifices 130 and through the orifices 130 at a rate of about 10,000 feet per minute. A range of speeds might be 8,000 feet per minute to 12,000 feet per minute, in some embodiments of the invention. Indeed, in some embodiments, the rate may be variable (sometimes automatically) by the system in which the dryer tunnel 100 is utilized.

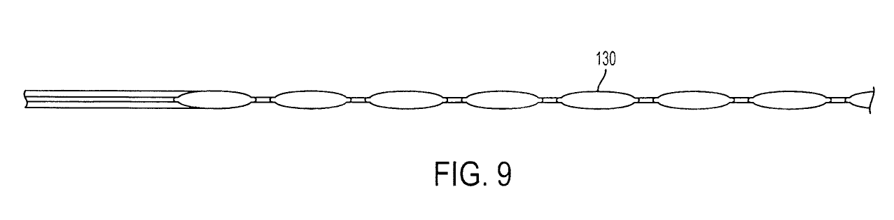

In some embodiments of the present invention, the second set of channels 126 on the second side 129 of the corrugated impingement shroud 120 opposite the first side 128 (see FIGS. 2 and 11) are used to direct air that has traveled through the orifices 130 towards the exhaust air outlet 140. The air dryer tunnel 100 may include elongated dividers located on the second side 128 of the corrugated impingement nozzle shroud 120. The elongated dividers 160 may be positioned between apexes of the corrugated impingement nozzle shroud 120 and may include exhaust openings 162. The exhaust openings 162 may be in fluid communication with the orifices 130 and the exhaust air outlet 140. In some embodiments, the dividers 160 are configured to isolate an exhaust section of the air dryer tunnel 100 from an impingement section of the air dryer tunnel 100. By way of example only and not by way of limitation, the total area of the orifices 130 may be ¼ of the total area of the exhaust openings 160 in the tunnel 100. It is noted that diameters of the various orifices and exhaust openings may vary both from design to design and within a given design (i.e., some orifices of a corrugated impingement nozzle shroud may be larger than other orifices, etc.) In some embodiments, the median diameter of the exhaust openings is substantially greater than median diameter of the orifices. For example, the median diameter of the exhaust openings may be about four times that of the orifices. Positioning of the nozzle orifices and the ratio between the total area of orifices and exhaust openings may be varied during the design process to balance air flow through the tunnel to achieve desired results. An exemplary embodiment of the layout of the orifices 130 may be seen in FIG. 9.

As detailed above, the dryer tunnel 100 according to some embodiments of the present invention includes an air inlet 110 and an air outlet 140. Some embodiments of the present invention are configured to utilize common air supply ducts and exhaust ducts which may be associated with a printing press and/or the facility in which the printing press is utilized. As noted, some embodiments of the present invention include an air inlet 110 that receives heated air which may be obtained from a resistance heater 300. Other embodiments may receive heated air through air inlet 110 from other forms of some other heating devices. Other embodiments of the present invention may not utilize heated air at all. Some embodiments of the air dryer tunnel 100 may include an exhaust duct 450 attached to the tunnel 100 in fluid communication with the exhaust air outlet 140.

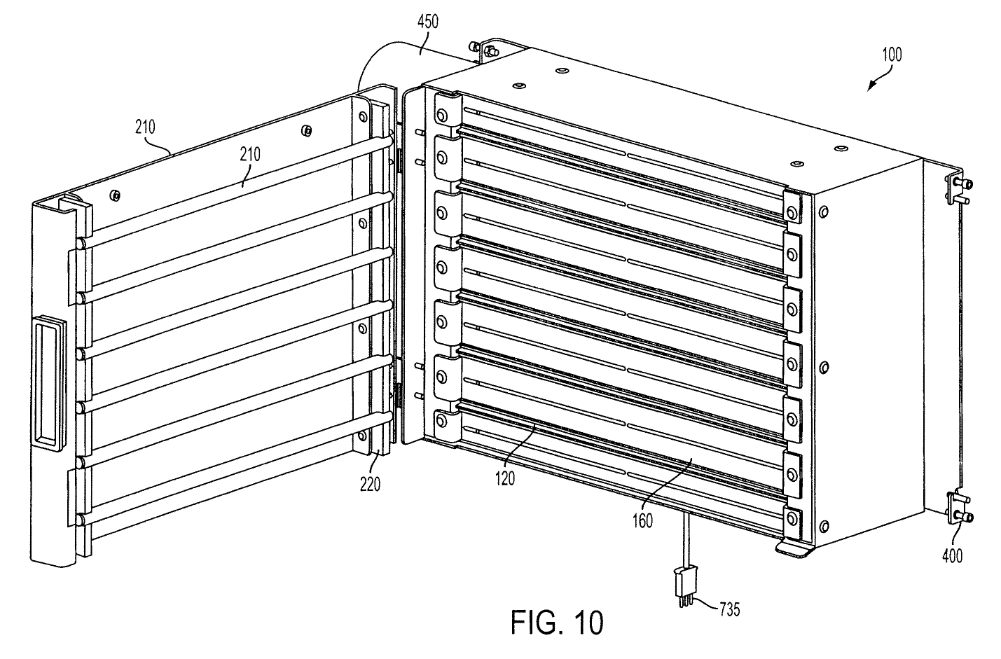

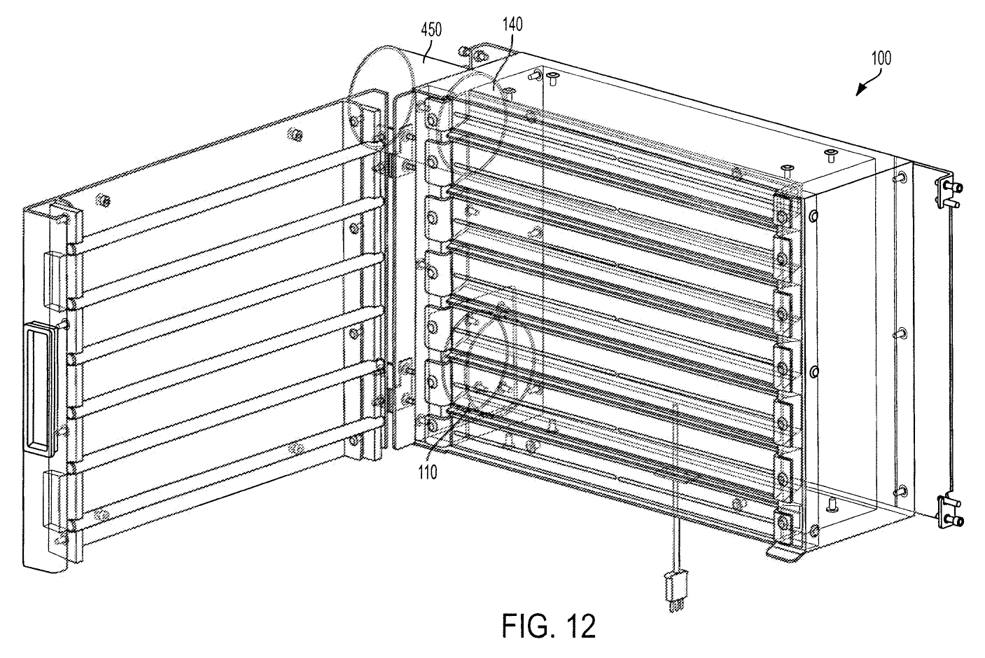

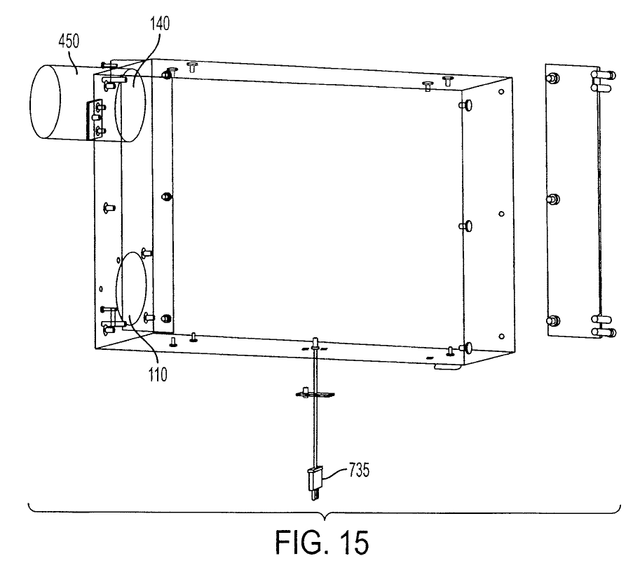

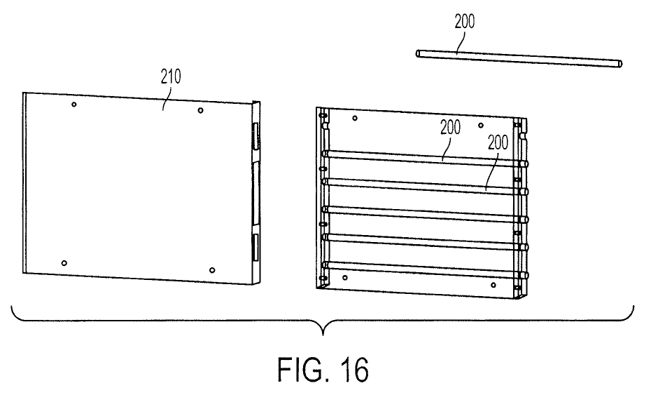

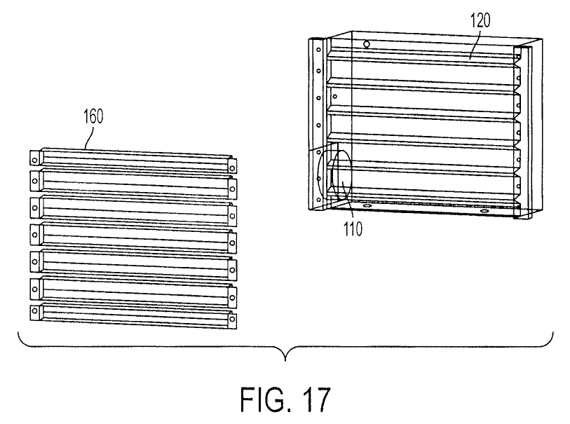

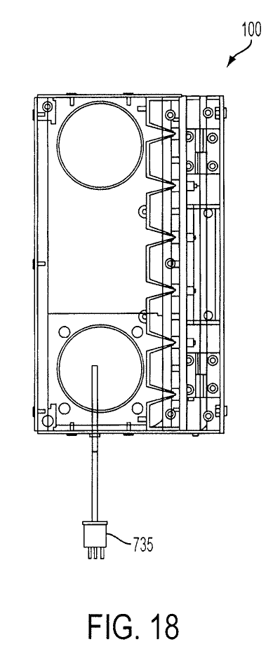

FIGS. 10-18 present additional schematics of various embodiments of the present invention. In FIG. 10 (as well as others), temperature sensor 735 may be seen, which may be utilized to monitor the temperature of the air passing through the tunnel. FIG. 12 presents a transparent view of the tunnel depicted in FIG. 10.

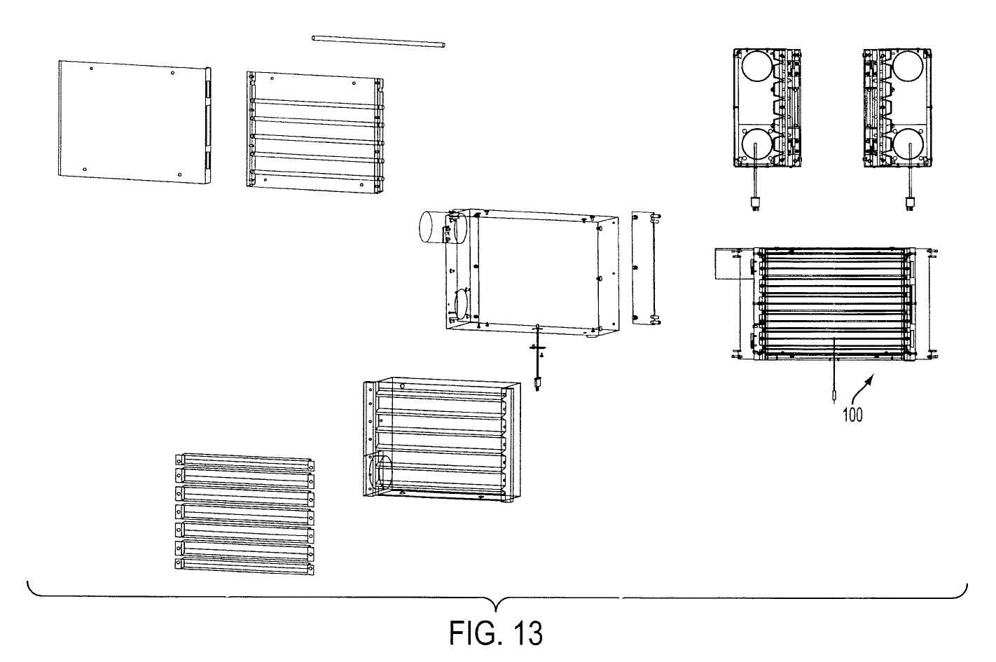

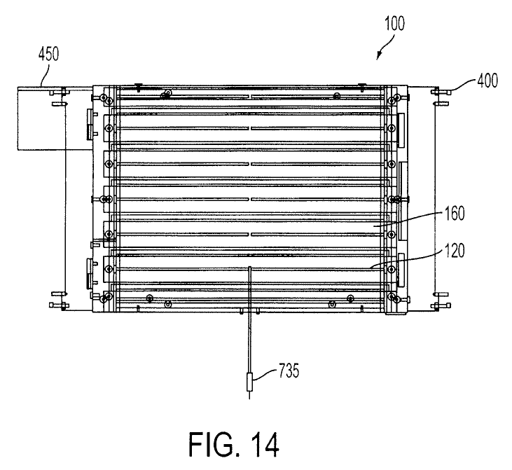

FIG. 13 presents an assembly schematic depicting various components and cross-sectional views of an embodiment of the present invention. FIGS. 14-18 present more detailed views of the components depicted in FIG. 13.

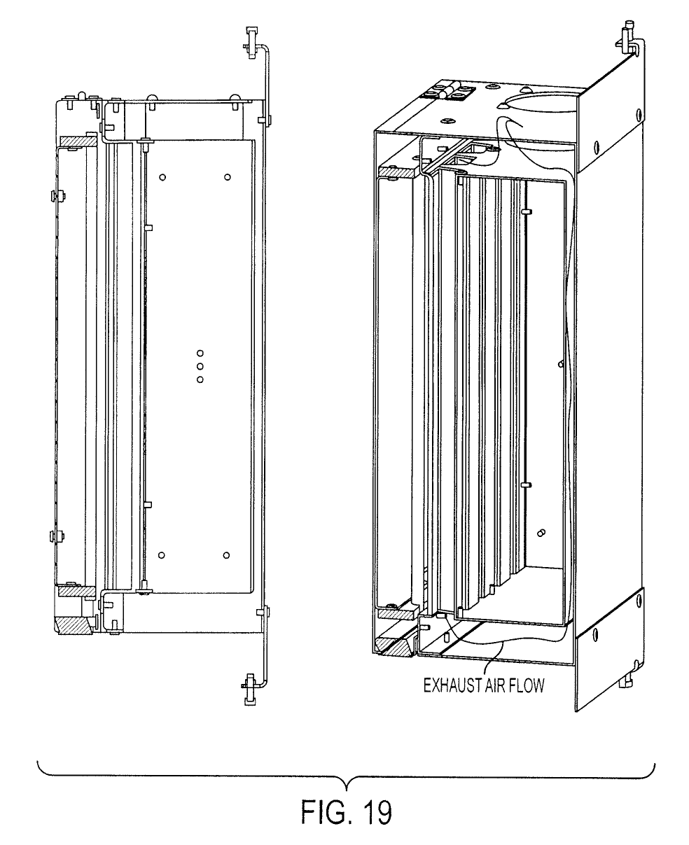

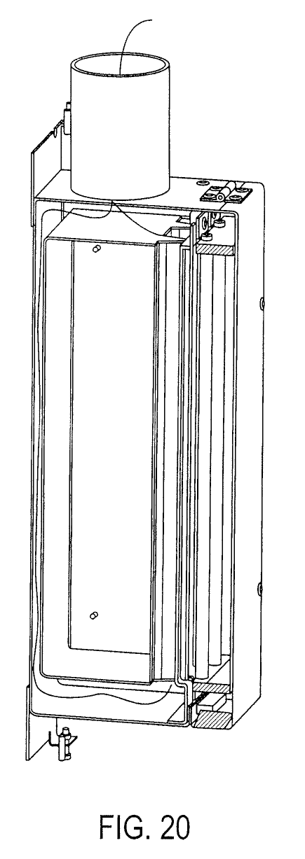

FIGS. 19 and 20 depict the flow of exhaust air through the tunnel 100.

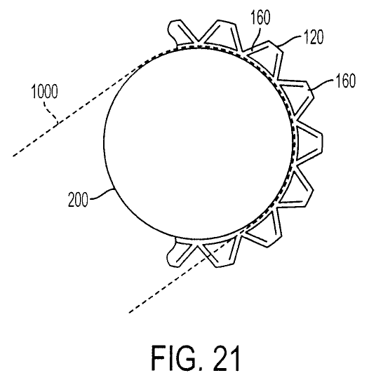

In some embodiments of the present invention, the air dryer tunnel 100 includes an arcuate shaped impingement nozzle shroud, such as that shown in FIG. 21. Here, the support 200 is a cylinder or the like. In such embodiment, the air dryer tunnel may be modified as necessary to accommodate the arcuate shape of the impingement nozzle shroud.

Given the disclosure of the present invention, one versed in the art would appreciate that there are other embodiments and modifications within the scope and spirit of the present invention. Accordingly, all modifications attainable by one versed in the art from the present disclosure within the scope and spirit of the present invention are to be included as further embodiments of the present invention.

What is claimed is:

1. An air dryer tunnel, comprising:
an impingement section, including:
an air inlet; and
a corrugated impingement nozzle shroud including rows of orifices positioned at least one of at and proximate apexes of the corrugation of the nozzle shroud, the orifices being in fluid communication with the air inlet;
an exhaust section, including:
an exhaust air outlet in fluid communication with the orifices of the impingement nozzle shroud.

2. The air dryer tunnel of claim 1, wherein the corrugated impingement nozzle shroud comprises a single sheet of metal.

3. The air dryer tunnel of claim 1, wherein the corrugated impingement nozzle shroud comprises a single piece of stamped sheet metal.

4. The air dryer tunnel of claim 1, wherein the corrugated impingement nozzle shroud includes corrugation in the form of V shaped channels substantially parallel to one another.

5. The air dryer tunnel of claim 1, wherein the corrugated impingement nozzle shroud include flat sections linking the legs of the V shaped channels that are horizontal when the V shaped channels are viewed upright.

6. The air dryer tunnel of claim 1, wherein the corrugated impingement nozzle shroud includes corrugation that forms a first set of channels substantially parallel to one another having a triangular cross-section in a plane normal to the direction of the first set of channels.

7. The air dryer tunnel of claim 6, wherein the corrugated impingement nozzle shroud includes corrugation that forms a second set of channels substantially parallel to one another having a trapezoidal cross-section in a plane normal to the direction of the second set of channels, wherein the second set of channels are opposite the first set of channels with respect to sides of the impingement nozzle shroud, wherein channels of the first set and second set are located in an alternating manner in a direction normal to the direction of the channels; and wherein first respective legs of the triangular cross-sections are shared with first respective legs of the trapezoidal cross-section and wherein respective second legs of the triangular cross-sections are shared with second legs of the trapezoidal cross-section, the first and second legs of the trapezoidal cross-section being the non-parallel legs of the trapezoidal cross-sections.

8. The air dryer tunnel of claim 1, wherein:
the air dryer tunnel is configured to create a pressure gradient such that air flows from the air inlet to the orifices and through the orifices;
the corrugated impingement nozzle shroud includes corrugation that forms a first set of channels on a first side of the corrugated impingement nozzle shroud to direct air from the air inlet to the orifices, channels of the first set of channels being substantially parallel to one another and configured to substantially increase velocity of the air moving from the air inlet to the orifices.

9. The air dryer tunnel of claim 8, wherein the corrugated impingement nozzle shroud includes corrugation that forms a second set of channels substantially parallel to one another on a second side of the corrugated impingement shroud opposite the first side to direct air that has traveled through the orifices towards the exhaust air outlet.

10. The air dryer tunnel of claim 9, wherein the exhaust section further comprises a plurality of elongated dividers located on the second side of the corrugated impingement shroud, wherein elongated dividers are positioned between apexes of the corrugated impingement nozzle shroud and include exhaust openings in fluid communication with the orifices of the impingement section and the exhaust air outlet, the dividers being configured to isolate the exhaust section from the impingement section.

11. The air dryer tunnel of claim 1, wherein:
the air dryer tunnel is configured to create a pressure gradient such that air flows from the air inlet to the orifices and through the orifices;
the exhaust section comprises exhaust openings in fluid communication with the orifices of the impingement section and the exhaust air outlet, wherein the orifices of the impingement section are in fluid communication with the exhaust openings, wherein the total area of the orifices is about ¼ of the total area of the exhaust openings.

12. The air dryer tunnel of claim 1, wherein:
the air dryer tunnel is configured to create a pressure gradient such that air flows from the air inlet to the orifices and through the orifices;
the exhaust section comprises exhaust openings in fluid communication with the orifices of the impingement section and the exhaust air outlet, wherein the orifices of the impingement section are in fluid communication with the exhaust openings, wherein the nozzle apexes are positioned about 2⅜ inches from each other.

13. The air dryer tunnel of claim 1, wherein:
the air dryer tunnel is configured to create a pressure gradient such that air flows from the air inlet to the orifices and through the orifices at a rate of about 10,000 feet per minute.

14. The air dryer tunnel of claim 1, further comprising a resistance heater configured to heat air flowing into the air inlet.

15. The air dryer tunnel of claim 1, further comprising a web support proximate to the corrugated impingement nozzle shroud, wherein the air dryer tunnel is configured to accept a paper web and permit the paper web to pass between the web support and the corrugated impingement nozzle shroud at a web running speed, the orifices of the corrugated impingement nozzle shroud configured to direct heated air onto the web that passes between the web support and the corrugated impingement nozzle shroud, the distance between the web support and the corrugated impingement nozzle shroud being adjustable.

16. The air dryer tunnel of claim 1, wherein the corrugated impingement nozzle shroud includes corrugation having a form selected from the group consisting of wave shaped channels, U shaped channels, converging hyperbola shaped channels, and V shaped channels, the channels being substantially parallel to one another.

17. The air dryer tunnel of claim 1, wherein the exhaust section further comprises:
a plurality of elongated dividers, wherein individual elongated dividers are positioned between apexes of the corrugated impingement nozzle shroud, and include exhaust openings in fluid communication with the orifices of the impingement section and the exhaust air outlet, the dividers being configured to isolate the exhaust section from the impingement section.

18. The air dryer tunnel of claim 1, wherein the orifices are substantially elliptical, where the major axis of the oval is about 0.130 inches and the minor axis is about 0.032 inches.

19. The air dryer tunnel of claim 1, wherein there are at least about 130 orifices per row, wherein the exhaust openings are in rows substantially parallel to the rows of orifices, wherein median diameter of the exhaust openings is substantially greater than median diameter of the orifices.

20. A method of manufacturing an air dryer tunnel for a printing press, comprising the actions of:
obtaining a piece of sheet material;
placing a plurality of rows of through holes in the sheet material;
plastically deforming the sheet material along the rows of through holes to impart corrugation in the sheet material, the rows of through holes being least one of at and proximate at least some apexes of the respective corrugation; and
attaching the sheet material to an air dryer tunnel including an air inlet such that the through holes are in fluid communication with the air inlet and at least some of the apexes of the corrugation of the sheet material having the through holes are away from the air inlet with respect to a direction of fluid traveling from the air inlet to the through holes.

21. The method of claim 20, wherein the through holes are punched through the sheet material and the plastic deformation action takes place subsequent to punching the holes through the sheet material.

22. The method of claim 20, wherein the plastic deformation action comprises stamping the sheet material to plastically deform the sheet material to obtain the corrugation.

23. The method of claim 20, wherein the plastic deformation includes deforming the sheet material to obtain corrugation in the form of V shaped channels substantially parallel to one another.

24. The method of claim 20, wherein the plastic deformation action comprises bending the sheet material along the rows of through holes to a predetermined angle.

25. The method of claim 20, further comprising attaching a plurality of elongated dividers to the air dryer tunnel such that the elongated dividers are positioned between apexes of the corrugation, the elongated dividers including exhaust openings such that the exhaust openings are in fluid communication with the orifices of the impingement section when attached to the air dryer tunnel.

26. A air dryer tunnel, comprising:
an impingement section, including:
a air inlet; and
a means for impinging air onto a web;
an exhaust section, including:
an exhaust air outlet in fluid communication with the orifices of the impingement nozzle shroud.

27. The air dryer tunnel of claim 1, wherein the impingement nozzle shroud is a plate.

28. The air dryer tunnel of claim 1, wherein the impingement nozzle shroud is in the form of an arcuate shroud.
